(19) United States
(12) Patent Application Publication
(10) Pub. No.: US 2008/0075035 A1
(43) Pub. Date: Mar. 27, 2008

(54) System and method for providing fast roaming

(75) Inventor: John Eichenberger, Tulalip, WA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec IP Corp., Everett, WA (US)

(21) Appl. No.: 11/525,431

(22) Filed: Sep. 22, 2006

(51) Int. Cl. H04Q 7/00

(52) U.S. Cl. 370/328

(57) ABSTRACT

A wireless STAtions (STA) that provides for fast roaming between access points (AP) by maintaining a scan list that is modified based on the results of previous roaming operations. The scan list dictates the order in which the STA scans channels for a satisfactory AP. By modifying the scan list to place channels previously identified as being used by AP's in higher priority positions, the amount of time required to identify a satisfactory AP in future scanning operations is reduced. In particular, the fast roaming STA places the channel used by an AP previously connected to the STA in the highest priority position in the scan list. In this way, channels used by APs previously connected to the STA populate the highest priority positions in the scan list, as the likelihood that the STA will connect to an AP on these channels in the future is very high.

### BACKGROUND OF THE INVENTION

The present invention relates to roaming within a wireless network. In particular, the present invention relates to a fast roaming algorithm that decreases hand-off time between access points.

Wireless local area networks (WLANs) allow wireless communication between devices located within the coverage area of the WLAN. In contrast to wired networks in which devices are constrained by the cables connecting them together, wireless networks allow devices to move freely within the area covered by the WLAN. This advantage has made WLANs popular in applications ranging from typical Internet communication, to inventory management, to voice over Internet protocol (VoIP).

WLANs typically include the following components: a wireless client or STAtions (STA) and at least one access point (AP). A STA includes any number of wireless devices capable of communicating using wireless protocols, such as cell phones, personal digital assistants (PDAs), laptops, or handheld devices. An AP is a device that forms a bridge between a wired network and the wireless network, distributing bandwidth provided by the wired network to wireless devices within transmission range of the AP. However, the transmission range of APs is typically fairly small (e.g. <100 feet) Therefore, a WLAN typically includes a number of APs located strategically to provide coverage to a desired area. As the STA moves within the WLAN, the STA will “roam” or associate with different APs depending on which AP is currently providing the strongest or best signal.

The process of transitioning from one AP to another AP is known as a “handoff.” The handoff process can be divided into several individual steps, including: hand-off initiation, scanning, and re-authentication. Hand-off initiation is the process by which the STA determines, based on the decreasing signal strength of the AP it is currently associated with, that a new AP must be located. This determination begins the hand-off process. In the next step, the STA scans available channels (i.e., the channels available in the wireless protocol used by the STA) to locate an AP providing the strongest signal. Following identification of the new AP to which the STA decides to roam, the STA must provide authentication to the new AP and transfer the STA's credential from the old AP to the new AP.

During the hand-off process, the STA is typically unable to communicate with the AP with which it is currently associated. In applications such as VoIP, this period of delay during hand-offs results in an unacceptable disruption of service. Studies have shown that scanning available channels for a new AP accounts for 90% of the latency associated with a hand-off operation. Therefore, it would be beneficial to reduce the hand-off latency associated with roaming operations. In particular, it would be beneficial to reduce the amount of time required to scan for a new AP to which the STA can connect.

### BRIEF SUMMARY OF THE INVENTION

In one aspect of the present invention, a fast roaming algorithm employed in a mobile device dynamically determines the order in which channels are scanned during the scanning operation based on previous scanning and roaming operations. Intelligent ordering of the scan list reduces the number of channels scanned before an appropriate channel is located.

In another aspect of the present invention, the fast roaming algorithm determines for each channel scanned whether an associated AP identified on the scanned channel is providing a signal of sufficient quality. If the identified AP is providing a sufficient quality signal, then the fast roaming algorithm foregoes scanning any remaining channels and completes the handoff operation with the identified AP.

### BRIEF DESCRIPTION OF THE DRAWINGS

FIG. 1A is a diagram of a wireless network (WLAN) made up of several access points (AP) for providing wireless communication to a wireless STAtion (STA).

FIG. 1B is a functional block diagram of components within a STA device.

FIG. 2 is a flow chart of steps performed by the fast roaming algorithm.

FIG. 3 is a diagram of a scan list maintained by the fast roaming algorithm as the STA device roams to several APs in a WLAN.

FIG. 4 is a diagram of a scan list maintained by the fast roaming algorithm as the STA device connects to an AP that provides a preferred scan list of channels used by nearby APs.

### DETAILED DESCRIPTION

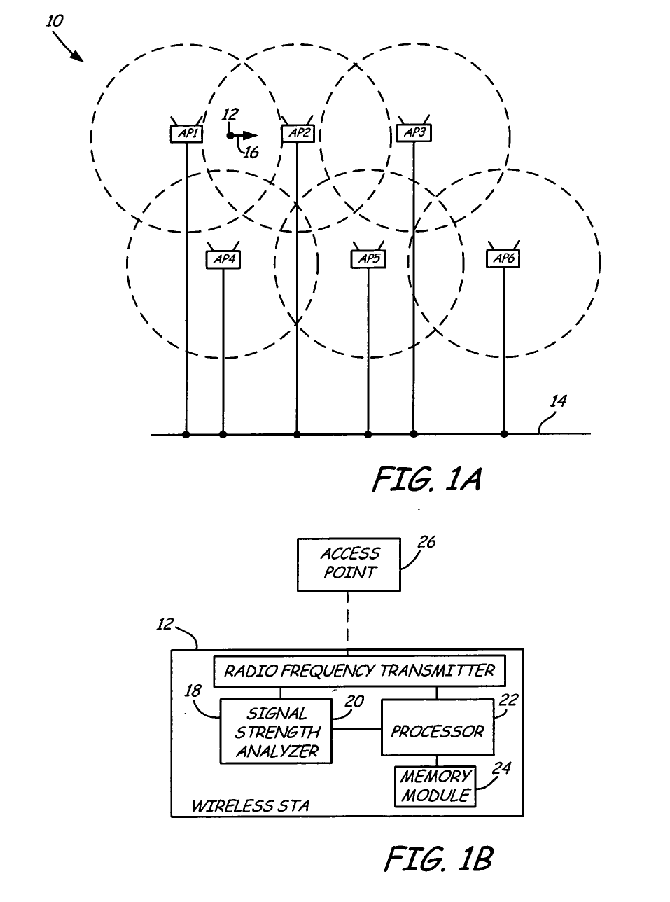

FIG. 1A illustrates wireless local area network (hereinafter, “WLAN”) 10, which is comprised of six wireless access points, labeled AP1, AP2, AP3, AP4, AP5, and AP6. Wireless STAtion or device 12 (hereinafter, “STA device 12”) is located within WLAN 10 and communicates with one of access points AP1-AP6 as necessary to maintain wireless communication with WLAN 10. In this embodiment, WLAN 10 is connected to wired network 14 (e.g., a wired Ethernet network), and distributes the bandwidth provided by wired network 14 to STA 12 and any other STAs located within the range of WLAN 10. In other embodiments, WLAN 10 may be connected to any number of data communication networks (wired or wireless).

As shown in FIG. 1A, each wireless access point AP1-AP6 provides wireless communication in a corresponding region (illustrated by dashed circles) surrounding each access point AP1-AP6. To ensure coverage of an entire region, access points AP1-AP6 are strategically located such that adjacent coverage regions overlap.

In this embodiment, wireless network 10 employs the IEEE 802.11(b) wireless communication protocol, although the principles discussed apply to any wireless protocol employed by a wireless network. The 802.11(b) protocol establishes a frequency range that is available for wireless communication and further divides the frequency range into a number of individual bands or channels. In the United States, the 802.11(b) protocol defines a total of eleven channels that may be used for wireless communication. To communicate with other network constituents, STA 12 determines which channel an adjacent AP is currently employing for transmission. Once STA 12 determines the channel being used by an adjacent AP, STA 12 associates or roams to the adjacent AP and begins communicating on the selected channel. To avoid interference and confusion regarding the AP with which STA 12 is associated, it is common to have adjacent access points communicate using different channels, although this is not required. For instance, in this embodiment, each access point AP1-AP6 is initialized or programmed to operate on the channels shown in Table 1 below.

TABLE 1

| ACCESS POINT | CHANNEL |
|---|---|
| AP1 | 1 |
| AP2 | 6 |
| AP3 | 11 |
| AP4 | 6 |
| AP5 | 11 |
| AP6 | 1 |

Therefore, access point AP1 (which communicates on channel 1) overlaps with coverage areas generated by access points AP2, AP4, and AP5, which operate on channels 6, 6 and 11, respectively.

In this embodiment (as well as in many real-world environments), channels 1, 6 and 11 are often employed as the preferred channels. In the 802.11(b) wireless protocol, only channels 1, 6 and 11 do not overlap in frequency with adjacent channels. That is, the frequency band assigned to channels 1 and 2 do not overlap with one another, but the frequencies assigned to channels 2 and 3 do overlap slightly. Furthermore, because channels 1, 6, and 11 are separated by a number of intermediate channels, there is little chance of interference between an AP operating on channel 1 and an AP operating on channel 6.

As STA 12 moves away from a current access point (e.g., AP1) the signal provided by AP1 will weaken, eventually requiring STA 12 to associate or roam to a new AP (e.g., AP2). This process of roaming from a first AP to a second AP is known as a “handoff” operation, which is conducted by the fast roaming algorithm employed by STA 12. The handoff operation can be described generally as including three stages, which include handoff initiation, scanning and re-authentication. Each of these operations is performed by the fast roaming algorithm, with the result of the process being the association of STA 12 with a satisfactory AP.

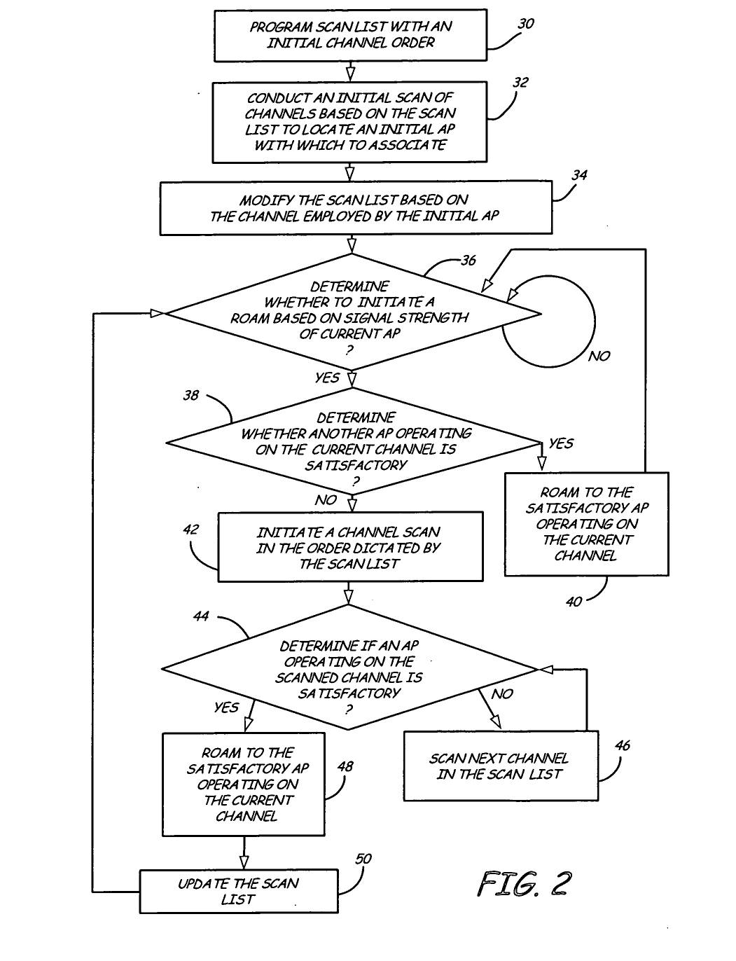

For example, STA 12 is currently connected to access point AP1 and moves in a direction indicated by arrow 16. As STA 12 moves away from access point AP1 the signal provided by AP1 will begin to weaken. The fast roaming algorithm continually monitors the strength of the signal provided by AP1 as part of the handoff initiation process. When the monitored signal drops below a level (known as the “trigger level”) determined by the fast roaming algorithm, then the fast roaming algorithm initiates the scanning process in order to locate a new AP with which to associate. During the scanning process, the fast roaming algorithm enters a “sleep mode” in which communication with access point AP1 is temporarily halted while the fast roaming algorithm scans available channels to locate an access point with which to associate. Using the algorithm detailed in the flowchart shown in FIG. 2, the fast roaming algorithm may determine that access point AP2 (using channel 6) is satisfactory. After identifying access point AP2 as being satisfactory, the fast roaming algorithm foregoes scanning other channels and associates, through a re-authentication process, with access point AP2. Thus, STA device 12 moves throughout WLAN 10, roaming as necessary between access points AP1-AP6. By decreasing the time associated with each roam operation, the overall performance of wireless network 10 is improved.

FIG. 1B is a functional block diagram of hardware employed by STA 12 to perform the fast roaming algorithm and to associate or connect with an AP. STA 12 includes radio-frequency (RF) transmitter 18, signal strength (channel) analyzer 20, processor 22, and memory module 24.

The hardware included within STA 12 operates to communicate with associated AP 26 and to perform roaming operations (using the fast roaming algorithm). Processor 22 controls operation of STA 12 and runs the software (such as the fast roaming algorithm) necessary to make decisions regarding roaming and data communication. At the request of processor 22, RF transmitter 18 sends and receives data to access point 26. In order to communicate with a particular AP (in this case, AP 26), RF transmitter 18 must be tuned to receive and transmit data on a channel selected by the AP. Furthermore, when scanning for a new AP with which to associate, RF transmitter 18 will be used to send and receive data on a channel being scanned to determine whether a satisfactory AP is currently operating on the scanned channel. To determine signal quality of the AP (either during normal operation or during scanning), signal strength analyzer 20 measures signal strength associated with an AP operating on a selected channel. In one embodiment, signal strength analyzer 20 measures the average signal strength (often referred to as a received signal strength indicator, or RSSI) of an AP to determine the quality of the signal provided by the AP. In another embodiment, signal strength analyzer 20 measures the signal to noise ratio (SNR) of an AP to determine the overall signal quality of an AP. The measured signal quality is communicated to processor 22, which uses the measured signal quality to make decisions regarding handoff initialization, scanning, and re-authentication with an AP. As part of this process, processor 22 generates and maintains a scan list (stored in memory module 24) that describes the order in which channels should be scanned during the scanning process. By dynamically modifying the scan list, processor 22 is able to dictate the order in which channels are scanned for roaming purposes. As discussed below with respect to FIG. 2, this ability to modify the order in which channels are scanned reduces the amount of time required to scan for an appropriate channel during a roaming operation.

FIG. 2 is a flowchart illustrating selection of an access point by a STA running the fast roaming algorithm. The flowchart illustrates the process by which the fast roaming algorithm determines when to initiate a roaming operation and the steps taken during the roaming operation to reduce the latency associated with a handoff between two access points.

At step 30, the fast roaming algorithm is programmed with a scan list that represents the order in which channels will be scanned by the fast roaming algorithm. For instance, in the 802.11(b) wireless communication standard, channels 1, 6 and 11 are popular choices for channels due to the separation in the frequency spectrum between each channel, as discussed above with respect to FIG. 1A. Therefore, the scan list may initially be programmed with channels 1, 6 and 11 at the front of the scan list to ensure that the STA device searches those channels first.

At step 32, following selection of the initial order of the scan list, the fast roaming algorithm conducts an initial channel scan, wherein the initial scan results in the fast roaming algorithm selecting a channel and associated access point with which to connect. In one embodiment, the initial channel scan may be conducted on all available channels, with the fast roaming algorithm selecting the AP with the strongest signal. In other embodiments, a channel scan is conducted until an AP is located that provides a satisfactory signal. In this embodiment, the scan time associated with identifying a satisfactory AP with which to associate is reduced. However, no information regarding the signal quality of additional APs is obtained.

At step 34, regardless of the scanning method employed (full scan or partial scan), the fast roaming algorithm modifies the scan list based on the channel selected at step 32. At the very least, the fast roaming algorithm removes the channel selected for communication from the scan list (i.e., the channel employed by the AP with which the STA device is now associated). As discussed above, adjacent access points typically operate on different channels. Therefore, a subsequent scan and roam operation performed by the STA device is unlikely to find an access point using the same channel as the access point to which the STA device is currently connected. In addition, in one embodiment the STA device is able to accumulate information regarding access points operating on the same channel as the access point to which the STA device is currently connected while maintaining an association with the current access point. If a second AP operating on the same channel as the AP currently associated with the STA device has satisfactory signal strength, then the STA device may decide to connect with the second AP without conducting a scan of channels remaining in the scan list. In both embodiments, by removing the channel employed by the AP to which the STA device is currently connected from the scan list, the number of channels to be scanned in a subsequent scanning operation is reduced, thereby reducing the amount of time required to roam to a subsequent AP.

In addition, if a full scan of all available channels was performed as step 32, then at step 34 the fast roaming algorithm may make additional modifications to the scan list based on the results of the full scan. Because all channels have been scanned, the channels and associated signal strength of other local APs may be determined. Based on the associated detection and measured signal quality of these APs, the fast roaming algorithm modifies the scan list to elevate the channels associated with detected APs to the front or highest priority positions in the scan list. In one embodiment, the channels associated with the highest quality AP signals are placed in the front or highest priority position of the scan list.

At step 36, the fast roaming algorithm determines whether to initiate a roaming operation to a new AP. As described above, this is the first step (often called handoff initiation) in roaming from a first access point to a second access point. The handoff initiation determines whether the signal provided by the AP to which the STA device is currently connected is no longer satisfactory, such that the scanning operation for a new AP should be initiated. This determination may be based on a number of factors, including but not limited to the following: average signal strength (often referred to as received signal strength indicator, or RSSI), signal to noise ratio (SNR) analysis of signal strength, or timeout threshold. The average signal strength calculates the signal strength associated with packets of data received by the STA device. The calculated RSSI value is compared with a threshold value (called “the trigger value”). When the RSSI falls below the trigger value, the fast roaming algorithm initiates a scan.

In another embodiment, instead of comparing the RSSI value to a trigger value, the STA device compares a calculated SNR value to an SNR threshold or trigger value to determine whether to initiate a roaming operation. The SNR value is calculated by subtracting a noise floor value associated with the current AP from the RSSI value measured with respect to the current AP. An approximation of the noise floor value may be calculated at the time the response was received or may be calculated based on a historical record of the noise floor associated with each AP. Because of instantaneous fluctuations in the noise floor, the historical record of the noise floor (i.e., an average) associated with each AP may provide improved performance in determining whether to initiate a scanning operation. In one embodiment, if the historical record of the noise floor is insufficient, the STA device may instead employ the measured RSSI value to determine whether to initiate a roaming operation. In particular, the historical record of the noise floor may be unsatisfactory for use in calculating the SNR value if the sample size of noise floor readings is limited. For example, when a STA device first begins operating in a wireless network, the historical record of the noise floor will initially be limited. Furthermore, if the noise floor readings for a particular AP are not very recent in time, then the usefulness of the measured historical noise floor value may be limited.

Another factor that may be used in conjunction with the RSSI threshold or SNR threshold is a timeout threshold. If the STA device goes for a specified amount of time without receiving a beacon from the associated access point, then the fast roaming algorithm initiates a scan. Depending on the application, the RSSI threshold value and timeout threshold may be adjusted depending on the wireless network in order to maximize performance.

If the fast roaming algorithm determines, based on factors such as RSSI threshold and timeout threshold, that the signal provided by the access point to which the STA device is currently associated is satisfactory, then the fast roaming algorithm does not initiate a scan. In this case, the fast roaming algorithm continues to communicate with the associated access point while continuing to monitor signal strength of the associated AP to determine whether to initiate a roam.

If at step 36 the STA device determines that the AP with which it is currently associated is not satisfactory, then at step 38 the STA device determines whether there are any other APs operating on the current channel that are satisfactory. As discussed above, the STA device may also receive beacons associated with other APs operating on the same channel as the AP to which the STA device is currently connected. If the STA device locates a second AP operating on the same channel as the AP to which the STA device is currently connected, then the STA device will roam to the second AP at step 40 without having to initiate a scanning operation.

If the fast roaming algorithm determines that the signal provided by the access point to which the STA device is currently connected is unsatisfactory at step 36, and no suitable AP operating on the same channel as the AP to which the STA device is currently connected is located at step 38, then the fast roaming algorithm initiates a channel scan at step 42.

The channel scan initiated by the fast roaming algorithm at step 42 scans channels in the order provided by the scan list. Channel scanning may be performed either passively or actively. Passive scanning of a particular channel involves listening for activity on the selected channel. If after a set amount of time no activity is detected, then the fast roaming algorithm determines that the channel is not being used by an access point within range of the STA device, and selects the next channel on the scan list. In contrast, active scanning involves sending a probe request on the channel being scanned. If an access point is operating on the selected channel, then the access point will respond to the probe request with a probe response, alerting the STA device to the presence of an access point operating on the selected channel. Depending on the application, either passive or active scanning may be employed, although active scanning is typically more efficient.

At step 44, based on the passive or active scan of a particular channel, the fast roaming algorithm determines whether the signal provided by an access point operating on the scanned channel is sufficiently better than the signal provided by the access point to which the STA device is currently connected. If the signal provided by the access point operating on the scanned channel is better, then the STA device decides to roam to the new access point. A number of factors may be reviewed by the fast roaming algorithm to determine whether to roam to the new access point. These factors include, but are not limited to the following: (1) a count of how many responses were received from the new access point by the STA device; (2) the RSSI value associated with each such response; (3) an indication of how much interference (or noise) is present on each channel; (4) the basic service set identification (BSSID) or Media Access Control (MAC) address of the AP for each response; and (5) the capabilities and data rates reported for each response. For example, in one embodiment the fast roaming algorithm may simply measure the RSSI value associated with an AP on the scanned channel. If the RSSI value is above a certain threshold value, then the fast roaming algorithm prepares to roam to the AP on the scanned channel.

In another embodiment, the amount of noise measured on a particular channel may be used to compute a signal to noise ratio (SNR) value that can be used in place of or in conjunction with the measured RSSI value to determine whether an AP operating on a scanned channel is satisfactory. As discussed above with respect to step 36, the SNR value is calculated by subtracting the measured noise floor value from the RSSI value. An approximation of the noise floor value may be calculated at the time the response was received or may be calculated based on a historical record of the noise floor associated with each AP. The SNR value may be compared to a threshold value to determine whether the STA device should roam to the AP on the scanned channel.

In another exemplary embodiment, the threshold used at step 44 is different from the trigger level used at step 36 to determine whether the RSSI signal strength associated with a current AP is sufficiently low to necessitate roaming to a new access point. For example, the threshold used at step 44 may be several decibels (dBs) higher than the trigger level used at step 36. Setting the threshold value used at step 44 higher than the trigger level ensures that a roam to a new channel is only performed when the AP operating on the scanned channel is of significantly higher quality than the current AP to which the STA device is connected. This prevents the situation in which the STA device is continuously roaming between two relatively equal in strength access points. Continuous scanning and roaming to new channels decreases the performance of the STA device, with more time spent scanning and roaming to new channels than communicating with an access point.

If the fast roaming algorithm determines that a scanned channel does not contain any satisfactory access points with which to connect, then the fast roaming algorithm selects the next channel on the scan list at step 46, and returns to step 44 to determine if any APs operating on the scanned channel are satisfactory. The process repeats, with the fast roaming algorithm scanning each channel in the order they appear in the scan list, until a satisfactory access point is found. If the fast roaming algorithm determines that a scanned channel is satisfactory, then at step 48 the fast roaming algorithm causes the STA device to roam to the satisfactory AP. A roam to the satisfactory AP includes re-authenticating the STA device with the selected AP, which in effect causes the STA device to terminate the connection made with the previous AP and associate with the newly selected AP.

The method described above is different from the prior art method, in which the scanning algorithm scans every channel available on the wireless protocol, and then selects the AP providing the strongest or highest quality signal. Thus, the prior art method required scanning each available channel during each roaming operation. The fast roaming algorithm scans channels (in the order provided by the scan list) until a satisfactory (although not necessarily best) access point is located. In this way, the fast roaming algorithm avoids having to scan every channel during a roam operation.

At step 50, following re-authentication and connection with the newly identified AP, the fast roaming algorithm updates the scanning list. Updating the scanning list includes adding the previous channel (i.e., the channel used by the access point previously associated with the wireless device) to the scanning list, and removing the current channel (i.e., the channel roamed to at step 48) from the scanning list. Because the fast roaming algorithm knows that the previous channel is used by at least one access point (and likely, other access points as well) in the immediate area, the previous channel is added to the front or near the front of the scanning list. This ensures that in subsequent scans of available channels, the previous channel will be one of the first channels scanned, thereby reducing the time required to scan for a satisfactory AP with which to connect. As stated above with respect to FIG. 2, because the fast roaming algorithm only scans channels until a satisfactory (although not necessarily best) access point is located, the priority ordering of channels in the scan list lowers the number of channels that must be scanned on average during a roam operation. By scanning fewer channels, the latency associated with handoffs between access points is improved.

Furthermore, by removing the current channel from the scanning list, the fast roaming algorithm ensures that the next scanning operation does not waste time scanning the channel currently used by the access point associated with the STA device. As discussed above, the STA device is able to detect the presence of APs operating on the same channel as the AP to which the STA device is currently connected without having to perform a scan. In addition, it is typically unlikely that adjacent APs would be operating on the same channel.

Following the update of the scanning list, the fast roaming algorithm returns to step 36 and continues monitoring the strength of the current channel until such time as the fast roaming algorithm determines that a roaming (handoff) operation should be performed.

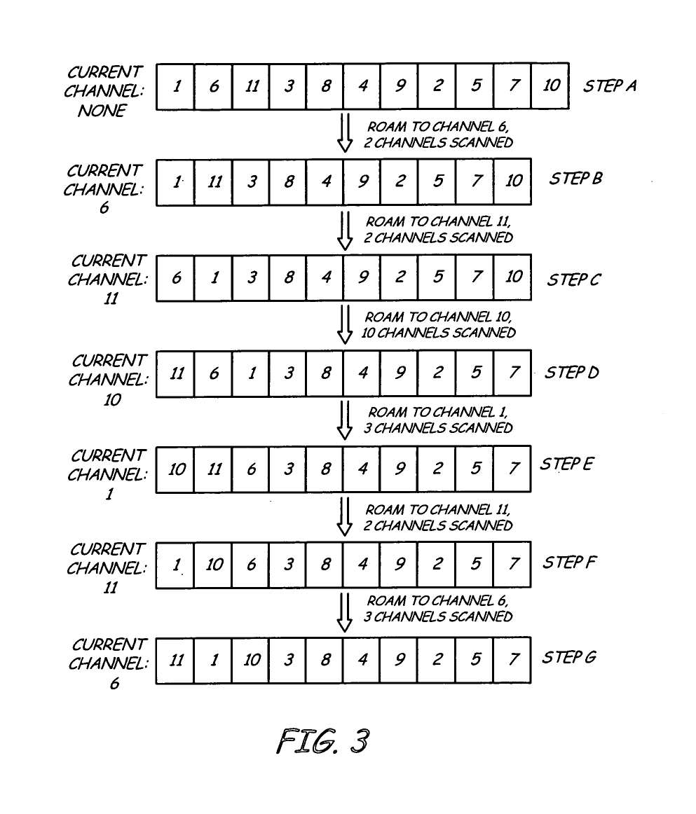

FIG. 3 is a diagram illustrating how the scan list is updated (illustrated by scan lists A-G) as the fast roaming algorithm roams to multiple access points in a wireless network. As discussed with respect to FIG. 2, the scan list maintained by the fast roaming algorithm defines the order in which the fast roaming algorithm searches for a new channel during a scan and roam operation. The head of the list (shown on the far left) represents the first channel to be scanned, and the tail of the list (shown on the far right) represents the last channel to be scanned. When a satisfactory AP operating on a scanned channel is located by the fast roaming algorithm, the channel employed by the satisfactory access point is removed from the scan list, and the channel employed by the previous access point is added to the head or top of the scan list.

An example of this process is illustrated in FIG. 3, in which the scan list is updated (in steps A-G), as the STA device connects with different APs. As shown in scan list A, the initial or pre-programmed scan list includes all eleven channels used by the 802.11(b) wireless communication standard. Although in this embodiment, the STA device only searches channels used by wireless communication protocol 802.11(b), in other embodiments, the STA device may operate in a wireless network that employs more than one wireless communication protocol. If multiple communication protocols (e.g., 802.11(b) and 802.11(g)) are being employed, then the scan list used by the STA device will include channels used by both of the communication protocols.

In the present example, channels 1, 6 and 11 are included in the highest priority positions of the scan list because of the likelihood that an AP is using one of these three channels (popular in the IEEE 802.11(b) protocol). At step B, a successful scan results in the wireless device roaming to channel 6, resulting in channel 6 being removed from the scan list. Because this is the first channel roamed to by the STA device, no channel is returned to the scan list.

At step C, the scan list is updated after a successful roam to an AP operating on channel 11. Once again, the channel being roamed to (channel 11) is removed from the scan list. In this case, because there is a previously active channel (channel 6), the scan list is modified to add the previously active channel to the top of the scan list. The remaining channels in the scan list are pushed down one position by the addition of channel 6 to the top of the scan list.

At step D, the scan list is updated after a successful roam to channel 10. Because channel 10 was located in the lowest priority position in the scan list, all 10 available channels were scanned in order to identify and roam to channel 10. The channel being roamed to (channel 10) is then removed from the scan list. The scan list is once again modified to add the previously active channel (channel 11) to the top of the scan list. The remaining channels in the scan list are pushed down one position by the addition of channel 11 to the stop of the scan list.

Typically, a coverage area only makes use of three channels. In this situation, after roaming to each of the three channels used by access points in a wireless network, the top of the scan list will be populated with two of the three channels (the third channel will be active, and therefore not included on the scan list). For instance, as shown in scan list D, after successful roams to channels 6, 11 and 10, the top of the scan list is populated by channels 11 and 6. Unlike other roaming algorithms that scan each channel before selecting the best available channel, the fast roaming algorithm terminates scanning once a satisfactory channel is located. Therefore, searching for a satisfactory AP typically requires scanning two channels at the most. For instance, a subsequent roam to an AP operating on channel 6 would require the scanning of only two channels (channels 6 and 11) before a satisfactory AP is located. The improved efficiency greatly reduces the amount of time required to scan for a satisfactory channel during roam operations.

In the current example, the wireless network includes access points operating on channels 6, 11 and 10. As discussed above, it is typically desirable to create a wireless network in which channels are separated in the frequency spectrum from one another. In the present example, channels 10 and 11 represent adjacent frequencies in the radio frequency spectrum. Therefore, it is likely than an analyst reviewing the system would make a change to one of the access points using channels 10 and 11. For example, assume that the access point operating on channel 10 is reconfigured to use channel 1. At step E, the STA device connected to the access point previously using channel 10 is forced to roam. Assuming no other satisfactory access points are identified, the STA device eventually (after scanning channels 11 and 6) identifies and roams to channel 1. When the wireless device roams to channel 1, the previously used channel (channel 10) is pushed onto the top of the scan list, and the current channel (channel 1) is removed from the scan list.

At step F, the scanning algorithm roams to channel 11, and channel 1 is pushed onto the top of the scan list, resulting in channel 10 being pushed farther down the list. At step G, the scanning algorithm roams to channel 6, resulting in channel 11 being pushed onto the top of the scan list, and pushing channel 10 further down the list. This example illustrates how quickly unused channels are pushed from the top of the scan list, replaced by channels being actively used by the wireless network. As shown at step G, the top of the scan list is populated by channels 11 and 1 (active channel 6 has been temporarily removed from the list). Thus, roaming operations that result in the STA device roaming to APs operating on channels 1, 6 or 11 will require scanning at the most only two channels.

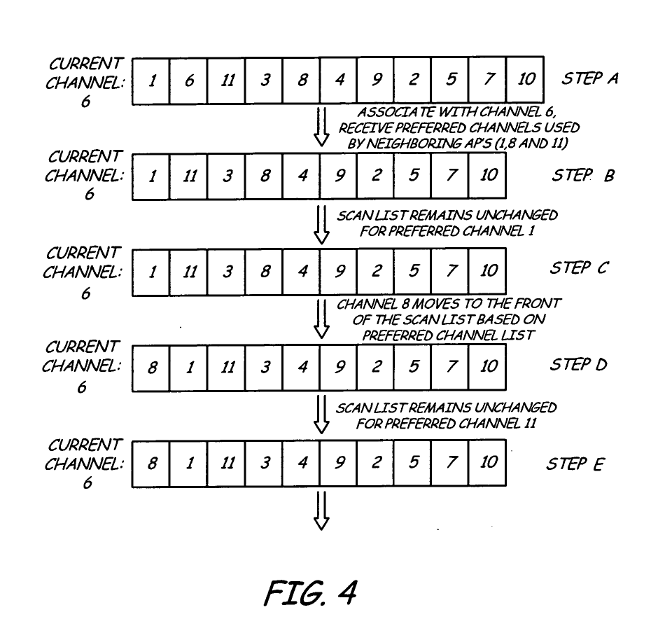

FIG. 4 illustrates a method of further modifying the scan list based on feedback received from an access point capable of communicating with adjacent access points. For example, the Cisco CCX protocol includes a method in which access points keep track of which channels were in use by clients prior to association with that AP. Based on the result of this query, the access point informs clients (such as STA devices) it is currently associated with of the channels being used by adjacent access points. Based on this information, the fast roaming algorithm implemented on the wireless device modifies the scan list accordingly.

At step A, the wireless device has not yet connected to an access point, so the scan list includes all 11 channels. Following a successful roam to an AP using channel 6, the scan list is updated by removing channel 6 from the scan list as shown in step B.

The access point then communicates to the wireless device a preferred channel list that includes those channels being used by adjacent access points. Based on the preferred channel list, the fast roaming algorithm modifies the scan list. In this example, the preferred channel list includes channels 1, 8 and 11.

At step C, the fast roaming algorithm incorporates the first channel on the preferred channel list (channel 1) into the scan list. In this case, however, channel 1 already holds the highest priority location in the scan list, so the scan list remains unchanged.

At step D, the fast roaming algorithm incorporates the second channel provided in the preferred channel list (channel 8) into the scan list. In this case, because non-preferred channels, such as channel 3, have higher priority than channel 8, the fast roaming algorithm moves channel 8 to the highest priority location. In other embodiments, the fast roaming algorithm would only move channel 8 ahead of non-preferred channels, but would not leapfrog preferred channels (such as channels 1 and 11). Either method of implementation results in preferred channels being placed in the positions of highest priority in the scan list.

At step E, the fast roaming algorithm incorporates the third channel provided in the preferred channel list (channel 11) into the scan list. Because channel 11 is preceded only by preferred channels (channels 1 and 8), the fast roaming algorithm leaves the scan list unchanged. Therefore, based on the feedback received from the access point with which the wireless device is currently associated, the top of the scan list is populated with the provided preferred channel list.

The present invention describes a method of fast roaming between access points. The fast roaming algorithm operates by modifying a scan list to include previously used channels in the highest priority locations. During subsequent scanning operations, the fast roaming algorithm searches those channels in the highest priority locations first. Once the fast roaming algorithm identifies an access point operating on a scanned channel that is satisfactory, the algorithm discontinues the scanning operation and proceeds to immediately associated with the satisfactory access point. In this way, the fast roaming algorithm reduces the number of channels on average that must be scanned in order to locate a suitable access point. Although the present invention has been described with reference to a number of embodiments, workers skilled in the art will recognize that changes may be made in form and detail without departing from the spirit and scope of the invention.

1. A method of fast roaming between access points (APs) for a wireless STAtion (STA), the method comprising:
initiating a scanning operation based on a measured quality of a signal connecting the STA to an initial AP operating on an initial channel;
scanning individual channels in an order dictated by a scan list until a satisfactory access point operating on a new channel is located;
roaming to the satisfactory access point operating on the new channel; and
updating the scan list by inserting the initial channel into a highest priority position in the scan list such that the initial channel is the first channel to be scanned in a subsequent fast roam operation, and removing the new channel from the scan list.

2. The method of claim 1, wherein initiating a scanning operation based on the measured quality of a signal connecting a STA to an AP includes:
measuring signal strength of the initial AP operating on the initial channel;
comparing the measured signal strength of the initial AP to a trigger level; and
initiating the scanning operation if the measured signal strength falls below the trigger level.

3. The method of claim 2, wherein measuring signal strength of the initial AP includes measuring at least one of the following attributes of the signal provided by the initial AP, including: an average received signal strength indication (RSSI) value and a signal to noise ratio (SNR) value.

4. The method of claim 1, wherein initiating a scanning operation based on the measured quality of a signal connecting a wireless STA to an initial AP operating on an initial channel includes:
measuring an amount of time that passes between successive beacons provided by the initial AP; and
initiating the scanning operation if the measured amount of time exceeds a timeout threshold value.

5. The method of claim 1, wherein scanning individual channels in an order dictated by the scan list until a satisfactory AP operating on a new channel is located includes:
1. selecting the highest priority unscanned channel from the scan list;
2. scanning the selected channel;
3. measuring a signal quality of an AP operating on the selected channel;
4. comparing the measured signal quality provided by the AP operating on the scanned channel with a threshold value;
5. identifying the measured signal quality as either satisfactory or not satisfactory based on the comparison of the measured signal quality of the AP with the threshold value, wherein if the measured signal quality is satisfactory then scanning of additional channels is foregone and the AP is identified as satisfactory; and
6. selecting the next highest priority channel in the scan list to scan if the measured signal quality of the AP is not satisfactory, and repeating steps 2-6 until a satisfactory AP operating on a scanned channel is located.

6. The method of claim 5, wherein measuring signal quality of an AP operating on the scanned channel includes:
measuring at least one of the following values associated with the signal quality of the AP on the scanned channel, including: a count of responses received from the AP, a received signal strength indication (RSSI) associated with the AP, a basic service set identification (BSSID) of the AP, a signal to noise ratio (SNR) associated with the AP, and capabilities and data rates reported for the selected channel.

7. The method of claim 6, wherein if the measured signal quality of the AP operating on the scanned channel includes the RSSI or SNR measurements, then the threshold value used to determine whether the AP operating on the scanned channel is satisfactory is greater than a trigger value used to determine when to initiate a scanning operation.

8. The method of claim 1, further including:
receiving a preferred list of channels used by adjacent access points from the initial access point to which the STA is currently connected; and
modifying the scan list based on the preferred list of channels used by adjacent access points to place the preferred list of channels in higher priority positions in the scan list than channels not in the preferred list of channels.

9. A wireless STAtion (STA) that provides fast roaming between access points (AP) in a wireless network, the STA including:
a radio-frequency (RF) transceiver for communicating with an associated AP operating on a selected channel;
a measuring component for measuring signal quality of access points operating on a selected channel;
a memory module for storing a scan list that dictates the order in which channels are scanned in a roaming operation; and
a processor for implementing a fast roaming algorithm, wherein the processor decides based on a measured signal quality provided by the radio-frequency transceiver of a current AP whether to initiate a scanning operation, wherein if the scanning operation is initiated, the processor instructs the RF transceiver and measuring component to scan channels in the order provided by the scan list until a satisfactory AP is identified, wherein the STA roams to the satisfactory AP and the processor updates the scan list based on the results of the roaming operation.

10. The STA of claim 9, wherein the measuring component measures at least one of the following characteristics to determine signal quality provided by the current AP, including: an average received signal strength indication (RSSI) value, a signal to noise ratio (SNR) value, and a measured time between successively received beacons.

11. The STA of claim 10, wherein the processor compares the RSSI or SNR value measured with respect to the current AP with a trigger value stored in the memory module to determine whether to initiate a scanning operation, wherein if the RSSI or SNR value measured with respect to the current AP is less than the trigger value then the processor initiates a scanning operation.

12. The STA of claim 10, wherein during the scanning operation the RF transceiver and the measuring component measure signal quality of AP's operating on a scanned channel, wherein the processor determines based on the measured signal quality whether the AP operating on the scanned channel is satisfactory or not satisfactory, wherein if the processor determines that the AP operating on the scanned channel is satisfactory then the processor foregoes scanning remaining channels and causes the STA to roam to the satisfactory AP.

13. The STA of claim 12, wherein during the scanning operation the RF transceiver and measuring component measure at least one of the following characteristics of AP's located on a scanned channel, including: a count of responses received from the AP, a received signal strength indication (RSSI) associated with the AP, a basic service set identification (BSSID) of the AP, a signal to noise ration (SNR) associated with the AP, and capabilities and data rates reported for the selected channel.

14. The STA of claim 13, wherein the processor determines whether an AP identified during the scanning operation is satisfactory by comparing the measured RSSI or SNR value measured with respect to the identified AP with a threshold value.

15. The STA of claim 14, wherein the threshold value used to determine whether the AP identified during the scanning operation is satisfactory is greater than the trigger value used by the processor to determine whether to initiate the scanning operation.

16. The STA of claim 15, wherein the processor modifies the scan list based on a preferred channel list received from the current AP.

17. A method of minimizing roam time for a wireless STAtion (STA), the method comprising:
updating an ordered list that determines the order in which channels are scanned during a scanning operation based on previous channels used by AP's connected to the STA;
scanning channels in the order determined by the updated ordered list until a satisfactory AP operating on a scanned channel is located, wherein the scan of additional channels is discontinued once a satisfactory AP has been located.

18. The method of claim 17, wherein updating the order of channels on the scan list includes:
inserting a channel used by an AP most recently connected to the STA into the highest priority location on the scan list; and
removing a channel employed by the AP currently connected to the STA from the scan list.

19. The method of claim 17, further including:
receiving a preferred channel list from the AP currently connected to the STA; and
further updating the order of channels on the scan list based on the preferred channel list received from the AP currently connected to the STA, wherein channels provided on the preferred channel list are moved to higher priority positions on the scan list.

20. A method of fast roaming between access points (APs) for a wireless STAtion (STA), the method comprising:
measuring signal quality of an initial AP with which the STA is currently associated;
measuring signal quality of additional APs operating on a same channel as the initial AP;
determining based on the measured signal quality of the initial AP whether a roaming operation to a new AP should be initiated;
determining whether one of the additional APs operating on the same channel as the initial AP is satisfactory based on the measured signal quality of the additional APs;
initiating a scanning operation in which individual channels are scanned in an order dictated by a scan list until a satisfactory access point operating on a new channel is located if no APs operating on the same channel as the initial AP are determined to be satisfactory;
roaming to a satisfactory access point; and
updating the scan list if the satisfactory access point is operating on a channel different than the initial channel by inserting the initial channel into a highest priority position in the scan list such that the initial channel is the first channel to be scanned in a subsequent fast roam operation, and removing the new channel from the scan list.
